(19) United States
(12) Patent Application Publication
(10) Pub. No.: US 2005/0023473 A1
(43) Pub. Date: Feb. 3, 2005

(54) System and method for reducing optical crosstalk in multi-anode photomultiplier tube

(76) Inventors: Kent Charles Burr, Latham, NY (US); James Walter LeBlanc, Niskayuna, NY (US)

Correspondence Address: Barry D. Blount;FLETCHER YODER, P.O. Box 692289, Houston, TX, 77269-2289, US

(21) Appl. No.: 10/878,071

(22) Filed: Jun. 28, 2004

Related U.S. Application Data
(63) Continuation-in-part of application No. 10/632,261, filed on Aug. 1, 2003.

(51) Int. Cl. G01T 1/20; H01S 3/00

(52) U.S. Cl. 250/368; 264/482

(57) ABSTRACT

A technique is provided for manufacturing a multi-anode photomultiplier tube for use in positron emission tomography (PET) detectors. One or more optical properties within an entrance window of the multi-anode photomultiplier tube are altered at a focal spot via a laser. The focal spot is translated relative to the entrance window for creating a three-dimensional pattern within the entrance window. This three-dimensional pattern having the one or more optical properties altered is adapted to control the spreading of optical photons within the entrance window.

### CROSS REFERENCE TO RELATED APPLICATION

This application is a Continuation-in-Part of U.S. patent application Ser. No. 10/632,261, entitled “METHOD FOR GENERATING OPTICAL ANISOTROPY IN SCINTILLATORS USING PULSED LASERS”, by Kent Burr filed on Aug. 1, 2003, which is herein incorporated by reference.

### BACKGROUND

The present invention relates generally to the field of non-invasive imaging and more specifically to the field of medical imaging. In particular, the present invention relates to method for reducing optical crosstalk in multi-anode photomultiplier tubes (PMTs).

Multi-anode PMTs are used in a variety of applications including various medical and non-medical imaging techniques. For example, in medical imaging techniques, such as positron emission tomography (PET), computed tomography (CT), single photon emission computed tomography (SPECT), and x-ray imaging, a detector is used to detect gamma rays or x-rays for subsequent processing. The detector generally consists of a scintillator block coupled to multiple PMTs or one or more multi-anode PMTs. The scintillator is used for translating gamma rays or x-rays into optical photons. The PMTs or multi-anode PMTs are used to detect the resultant optical photons and translate them into electrical signals. The position of the gamma ray or x-ray interaction is determined from a centroid calculation based on the relative amplitudes of the optical photons recorded on the different PMTs or different anodes within a multi-anode PMT. It is most common to use four channels (either four individual PMTs, 2 dual-anode PMTs, or one quad-anode PMT). The use of multi-anode PMTs is preferred because it reduces dead space, thereby improving detection efficiency, and reduces system cost (one quad PMT, for example, is significantly less expensive than four single PMTs of similar quality).

In order to be able to decode the maximum number of pixels in the detector, the spreading of optical photons within the scintillator block must be carefully controlled so that a distinct pattern of signal amplitudes will appear on the different PMT channels for each pixel within the block. Existing approaches to this control have addressed the problem by assembling scintillator packs or blocks from discrete elements, often separated by reflectors. Other approaches generate discrete elements by growing scintillator crystals with a fine needle-like structure. Assembling the scintillator blocks from these discrete elements, however, can be extremely time consuming, and relying on the growth of the needle-like scintillator crystals often does not allow for the precise control over optical properties using existing methods.

In the case of PET scintillator blocks, a wide variety of surface treatments and reflector elements have been used to control the undesirable sharing of optical photons between the discrete elements of the block. These treatments and applications may further complicate construction. Another method has been to use a saw to make deep grooves into the scintillator in a grid pattern to provide optical isolation between different regions of the scintillator. Often, such isolation is only partial. This saw cut method may result in the disadvantageous creation of relatively large dead areas by removal of the scintillator material.

However, even after significant effort and cost to control the spreading of optical photons within the scintillator block, the ability of the detector to discriminate between events in different pixels can be degraded by optical crosstalk within the entrance window of multi-anode PMTs. Once an optical photon enters the window of the multi-anode PMT, it is possible for the photon to experience multiple reflections from the surfaces of the glass entrance window before being absorbed in the photocathode. In some cases, the photon may exit from the top surface of the entrance window after multiple reflections. These multiple reflections can cause optical photons to travel a significant lateral distance within the entrance window before being detected. If the photon travels from its original entrance location to a region, which corresponds to a different channel of the multi-channel PMT before being absorbed, then that photon will contribute its signal to the wrong channel, resulting in a degradation of the ability of the detector to correctly position the gamma ray or x-ray interaction. This effect is particularly important for gamma ray interactions that occur near the edge of the multi-anode PMT, resulting in a significant reduction in the number of crystals or pixels that can be decoded. For certain angles of photon propagation within the entrance window, total internal reflection can result in an optical light guide effect, which may exaggerate the optical crosstalk effect by allowing photons to travel even greater distances before interacting with the photocathode.

It is therefore desirable to provide a multi-anode PMT that enables improved control of optical photon spreading within the entrance window without generating unwanted dead space. It is also desirable to provide a cost-effective and reliable method of manufacturing of multi-anode PMTs with the above benefits.

### SUMMARY

Briefly, in accordance with one aspect of the technique, a method of manufacturing a multi-anode photomultiplier tube is provided. The method provides for altering one or more optical properties within an entrance window of the multi-anode photomultiplier tube at a focal spot via a laser. The method also provides for translating the focal spot relative to the entrance window for creating a three-dimensional pattern within the entrance window. The three-dimensional pattern has one or more optical properties altered.

In accordance with another aspect of the technique, a multi-anode photomultiplier tube is provided. The multi-anode photomultiplier tube includes an entrance window having a three-dimensional pattern with one or more optical properties altered. The three-dimensional pattern is adapted to control spreading of optical photons within the entrance window.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts an exemplary PET imaging system for volumetric imaging using a detector ring in which aspects of the present technique may be practiced;

FIG. 2 depicts assembly of a detector ring using an array of detector units in which aspects of the present technique may be practiced;

FIG. 3 depicts a side view of a generic multi-anode PMT coupled to a scintillator block;

FIG. 4 depicts a method of manufacturing a multi-anode PMT with laser patterning in the entrance window for use in detector units in accordance with aspects of the present technique;

FIG. 5 depicts a multi-anode PMT in which lateral spreading of optical photons within the entrance window is controlled via the laser patterning in accordance with aspects of the present technique; and

FIG. 6 depicts a perspective view of the multi-anode PMT of FIG. 5 in accordance with aspects of the present technique.

### DETAILED DESCRIPTION OF EXEMPLARY EMBODIMENTS

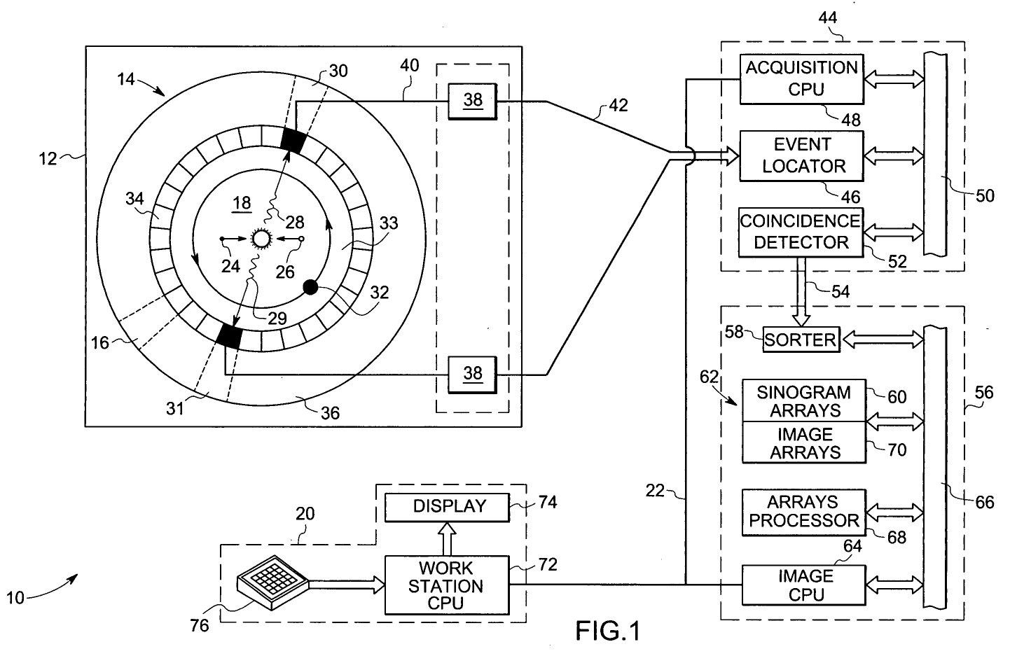

Referring now to FIG. 1, an imaging system 10 is illustrated for acquiring and processing image data. In the illustrated embodiment, the imaging system 10 is a PET system designed both to acquire original image data and to process the image data for display and analysis in accordance with the present technique. The PET imaging system 10 is illustrated with a gantry 12 that supports a cylindrical detector ring assembly 14, comprising of an array of detectors 16 (detector units), about a central aperture (imaging volume) 18. The detectors 16 may be shielded from radiation from outside the filed of view by lead end-shields. The detector ring assembly 14 generally forms a complete ring about the imaging volume 18. In one implementation, the gantry 12 may rotate through a small angle to average out gaps between the detectors 16.

A patient table may be positioned within the aperture 18 of the PET system 10. The patient table is adapted so that a patient may recline comfortably during the examination process. A patient table controller (not shown) moves the patient table into the imaging volume 18 in response to commands received from an operator workstation 20 through a communication link 22 such as a local area network (LAN). Additionally, a gantry controller (not shown) may be configured to receive commands from the operator workstation 20 through the communication link 22 to operate the gantry 12.

The patient is commonly injected with a biologically active radioactive tracer. This radioactive substance has two parts called a carrier such as glucose, which concentrates in parts of the body with increased metabolic activity, and the radionuclide, which emits a positron 24. Since positron 24 emitting isotopes of carbon, nitrogen, oxygen, and fluorine can be created and these atoms occur naturally in many compounds of biological interest, these radionuclides can therefore be readily incorporated into a wide variety of useful radio-pharmaceuticals. The type of tracer a patient receives depends on which area of the body is to be viewed. The most commonly used tracers are radiolabeled glucose, ammonia, and water, all of which are found in the human body. As the tracers are short-lived, the radiation exposure a patient receives is small. The tracer is allowed to dwell in the patient for a time such that its distribution is determined by the biological function to be imaged.

The radioactive decay of the tracer emits a positron 24 that annihilates with electrons 26 in the body of the patient. This annihilation produces two high energy (about 511 KeV) photons 28, 29 propagating in nearly opposite directions (about 180 degrees apart) that are in coincidence. These photons 28, 29 are detected by the detector ring assembly 14 surrounding the patient. When a detector 30 detects a photon 28 from an annihilation event, the detector 31 opposite it looks for a matching photon 29; and if two matching photons 28, 29 are recorded within nanoseconds of each other i.e. within a short timing window (also referred to as a coincidence timing window), the detectors 30, 31 register a coincidence event (called a true coincidence if neither photon 28, 29 is scattered) along the line connecting the two detectors 30, 31 also known as a line of response.

The PET system 10 may then draw lines of responses between each detector pair such as those indicated by reference numeral 30 and 31 registering a coincidence event during a scan. Summing many such events results in quantities that approximate line integrals through the radioisotope distribution. The higher the number of coincidences detected, the more precise this calculation will be. The system 10 then uses this information to construct an image of the radioisotope distribution, using algorithms similar to those applied in CT, MR and nuclear medicine, thereby yielding quantitative estimates of the concentration of the radiopharmaceuticals at specific locations within the body. For a good reconstruction, attenuation map of the patient may be used in order to correct for attenuation of the gamma rays or x-rays within the patient. In one implementation, the attenuation map may be obtained by rotating a radioactive source such as Cs 137 around the patient and measuring the attenuation along each line of response. Alternatively, a CT scan may be used to generate the attenuation map as in PET-CT system. The reconstructed images are cross-sectional slices that highlight areas of biochemical activity. While other diagnostic tests, such as x-rays, CT scans, MR scans or ultrasound, provide cross-sectional images of the body structure showing bones, tissue and organs, the PET scan can provide images of physiological activity giving information on the chemistry and function of the area under examination.

As illustrated in FIG. 1, each detector ring of the detector ring assembly 14 may comprise of a rod source 32 used for attenuation correction, a septa 33 used for scatter reduction, and a plurality of detector units 16 consisting of scintillator elements 34 and photomultiplier tubes 36 (PMTs). A plurality of acquisition circuits 38 may receive analog signals 40 from the detector units 16 and produce digital signals 42 indicating the event coordinates and the total energy. Each acquisition circuit 38 may also produce an event detection pulse, which indicates the moment the scintillation event took place. The digital signals 42 from the acquisition circuits 38 are then processed by a data acquisition system 44 (DAS).

The data acquisition system 44 may include an event locator 46 that periodically samples the digital signals 42 produced by the acquisition circuits 38. The data acquisition system 44 also includes an acquisition processor 48 that controls the communication link 22 and a data bus 50 (backplane bus). The event locator 46 may assemble the information regarding each valid event into an event data packet that indicates when the event took place and the position of the detector 16 that detected the event. This event data pack is conveyed to a coincidence detector 52, which may be a part of the data acquisition system 44.

The coincidence detector 52 may receive the event data packets from the event locators 46 and determine if any two of them are in coincidence. Coincidence is determined by a number of factors. First, the time markers in each event data packets may be within a specified time window of each other. Second, the locations indicated by the two event data packets may lie between a pair of detectors, such as those indicated by reference numeral 30 and 31, which may have a line of response that passes through the field of view in the imaging volume 18. Events that cannot be paired as such are discarded, but coincident event pairs are located and recorded as a coincidence data packet that is conveyed through a serial link 54 to an image reconstructor 56.

The image reconstructor 56 may include a sorter 58 that counts events occurring along each projection ray and organizes them into a two-dimensional sinogram array 60 that may be stored in a memory module 62. The image reconstructor 56 also includes an image processor 64 that controls a data bus 66 and links the image reconstructor 56 to the communication link 22. An array processor 68 also connects to the data bus 66 and it may reconstruct images from the sinogram arrays 60. A resulting image array 70 may be stored in the memory module 62 and output by the processor 64 to the operator workstation 20.

The operator workstation 20 may include a workstation processor 72, a display unit 74 and an input device 76. The workstation processor 72 may connect to the communication link 22. The operator may control the calibration of the PET scanner 10, its configuration, positioning of the patient table for a scan and the gantry 12 through operator workstation 20. The operator may also control the display of the resulting image on the display unit 74 and perform image enhancement functions using programs executed by the workstation processor 72. It should be noted that the operator workstation 20 may be coupled to other output devices such as printers, standard or special purpose computer monitors, associated processing circuitry or the like. One or more operator workstations 20 may be further linked in the imaging system 10 for outputting system parameters, requesting examinations, viewing images, and so forth.

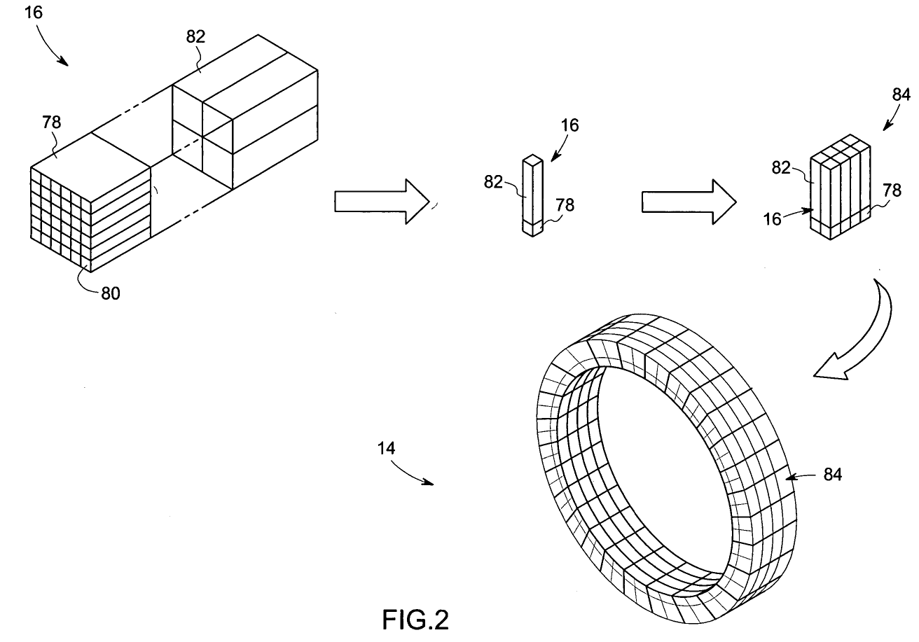

The exemplary imaging system 10, as well as other imaging systems based on radiation detection, may employ detectors 16 to detect the intensity of radiation 28, 29 transmitted through the imaging volume 18 and to generate a detector output signal in response to the detected radiation 28, 29. Referring now to FIG. 2, an exemplary embodiment for assembling the detector ring assembly 14 for use in the PET system 10 is depicted. In the depicted embodiment, the plurality of detector units 16 is assembled to form the detector ring assembly 14.

Each detector unit 16 includes a scintillator block 78, comprising one or more scintillator elements 80, that are optically coupled to one or more PMTs or one or more multi-anode PMTs 82. When a photon interacts in the scintillator element 80, electrons are moved from valence band to the conduction band. These electrons return to the valence band at impurities in the scintillator element 80, thereby emitting photons in the process. Because the impurities usually have metastable excited states, the photon output decays exponentially at a rate characteristic of the scintillator element 80. The ideal scintillator element 80 has high density and high atomic number so that a large fraction of incident photons scintillate. The ideal scintillator element 80 also generates a high photon output for each absorbed photon. This may result in better positioning accuracy and energy resolution. The ideal scintillator element also has a fast rise-time for accurate timing and a short decay time for handling high counting rates. For example, bismuth-germanate (BGO) crystals, which generate approximately 2500 light photons per 511 KeV photon, and have a decay time of about 300 ns may be used as a scintillator elements 80 to form the scintillator block 78. In one implementation, a matrix of 36 BGO crystals (6×6 array of BGO crystals) is coupled to four PMTs or one quad-anode PMT where each crystal is about 6.3 mm wide in the transverse plane, about 6.3 mm wide in the axial dimension, and about 30 mm deep, to form the detector unit 16. A group of detector units 16 is then assembled to form a detector module 84 and a group of detector module 84 is assembled to form the detector ring assembly 14. In one implementation, 8 detector units 16 are assembled to form the detector module 84 and 35 such detector modules 84 are assembled to form the detector ring assembly 14.

All of the PMTs or multi-anode PMTs 82 may produce analog signals when a scintillation event occurs at the scintillator block 78. The scintillator block 78 is fabricated in such a way that the amount of photons collected by each PMT or each anode of the multi-anode PMT 82 varies uniquely depending on the crystal 80 in which the scintillation occurred. Hence, integrals of PMT outputs can be decoded to yield the position of each scintillation. The sum of the integrated PMT outputs is proportional to the energy deposited in the scintillator block 78.

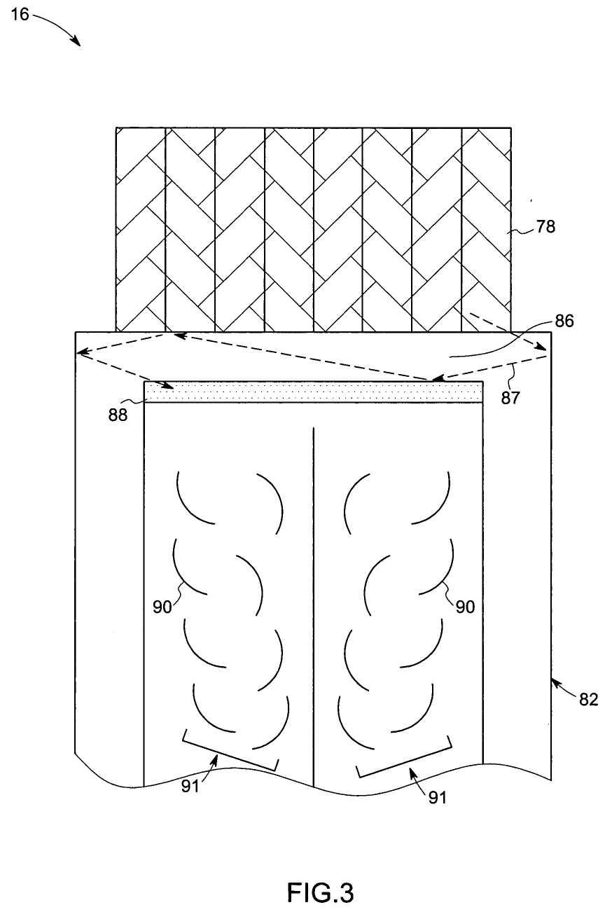

FIG. 3 depicts a generic detector unit 16 illustrating a side view of the generic multi-anode PMT 82 optically coupled to the scintillator block 78. The multi-anode PMT includes an entrance window 86 for receiving optical photons 87 from the scintillator block 78. It should be noted that the entrance window 86 may be made of any transparent material such as glass or ceramic. These optical photons 87 interact with a photocathode 88 to release electrons via photoelectric effect. The photocathode 88 may be composed of a photosensitive material such as alkali metals. The electrons emitted by the photocathode 88 are then accelerated by successive surfaces or dynodes 90 from which additional electrons are ejected. A voltage divider circuit may be used to apply increasing high voltages between successive dynodes 90, for an electron gain. The increase of electrons is proportional to the potential difference across each stage of the dynodes 90. In one implementation, the gain is about 3 per stage or 1 million overall. The electrons may then be captured by one or more anodes 91 of the multi-anode PMT 82, thereby producing an electrical signal. By analyzing these electrical signals, the number of optical photons 87 and their energy is determined for subsequent processing. In one implementation, the multi-anode PMT 82 may consist of four channels corresponding to the four anodes 91 of a quad PMT.

The position of the gamma ray or x-ray interaction in the scintillator block 78 may be determined from a centroid calculation based on the relative amplitudes of the signals recorded on the different anodes 91 of the multi-anode PMTs 82. Optical crosstalk within the entrance window 86 of the multi-anode PMTs 82 reduces the ability to correctly decode the gamma ray or x-ray interaction position, especially when the interaction occurs near the edge of the multi-anode PMT 82. As illustrated in the FIG. 3, once an optical photon 87 enters the entrance window 86 of the multi-anode PMT 82, it is possible for the optical photon 87 to experience multiple reflections from the surfaces of the entrance window 86 before being absorbed in the photocathode 88. In some cases, the optical photon 87 may exit from the top surface of the entrance window 86 after multiple reflections. These multiple reflections can cause optical photons 87 to travel a significant lateral distance within the entrance window 86 before being detected. If the photon travels from its original entrance location to a region, which corresponds to a different anode of the multi-anode PMT 82 before being absorbed, then that optical photon 87 will contribute its signal to the wrong anode, resulting in a degradation of the ability of the detector to correctly position the gamma ray or x-ray interaction. Thus, a controlled spreading of optical photons 87 in the entrance window 86 of the multi-anode PMT 82 is highly desirable for use in variety of application.

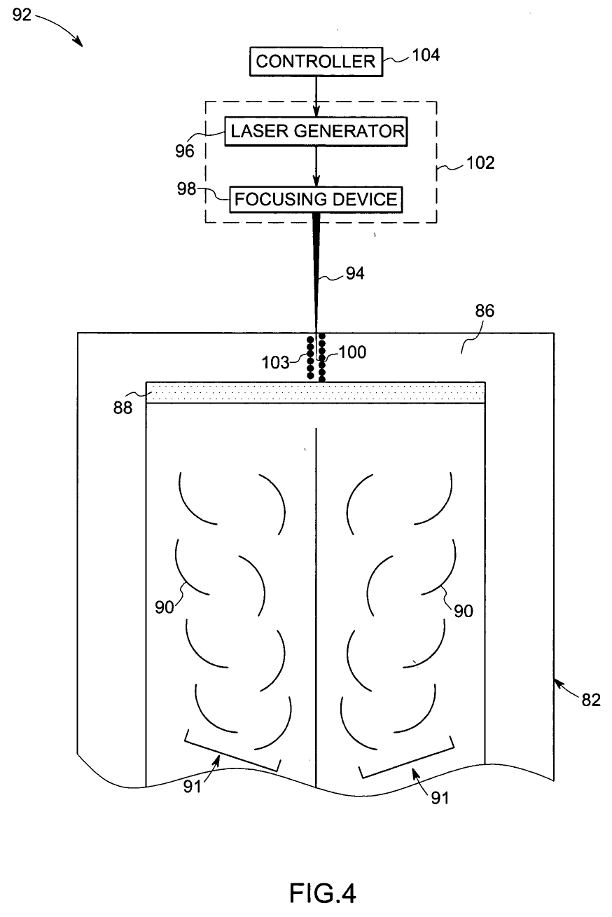

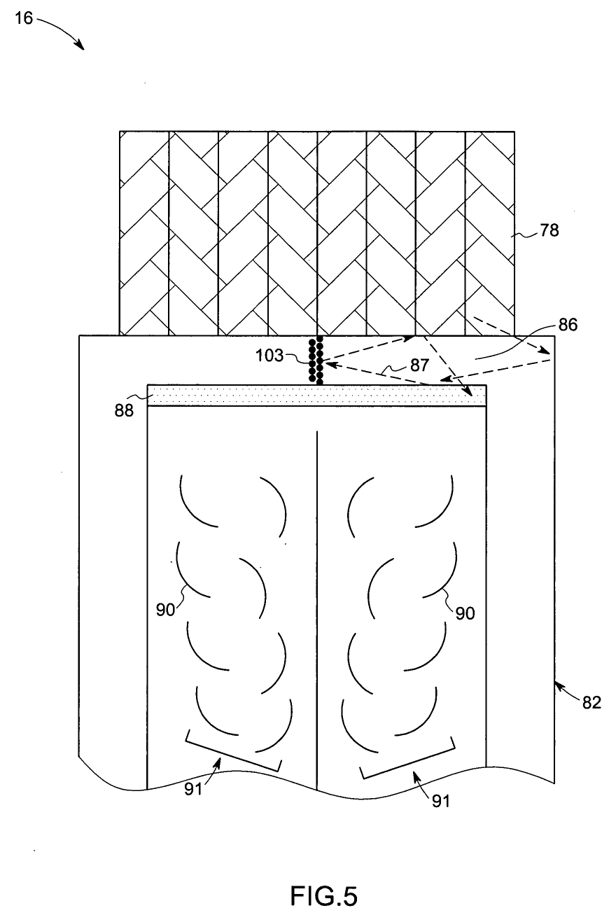

As illustrated in FIG. 4 and 5, a system 92 in accordance with aspects of the present technique may reduce undesirable spreading of the optical photons 87 by modifying the entrance window 86 of the multi-anode PMT 82 in such a way that optical photons 87 interact with the photocathode 88 near the corresponding anode 91 thereby reducing optical crosstalk and improving the detection efficiency. The entrance window 86 may be modified using a laser beam 94. A laser generator 96 is utilized to generate the laser beam 94. The laser beam 94, in turn, is focused into the entrance window 86 via a focusing device 98 at a focal spot 100 of the focusing device 98. The term “focal spot” is intended to encompass focal volume as well. The interaction of the laser beam 94 with the entrance window 86 results in a modification of the optical properties of the entrance window 86 at the focal spot (or focal volume). By translating the position of the focal spot 100 relative to the entrance window 86 via a translation device 102, a 3-dimensional pattern 103 can be created within the entrance window 86. This 3-dimensional pattern 103 controls the spreading of the optical photons 87 within the entrance window 86 and confines the optical photons 87 entering the entrance window 86 to the region of the entrance window 86 that it initially enters, thereby reducing optical crosstalk. Although the translation device 102 is illustrated as translating the position of the focal spot 102, it should be noted that the same effect may be accomplished through the relative movement of the entrance window 86. A controller 104 may be used to control the operation of the translation device 102 as well as the laser generator 96 and the focusing device 98.

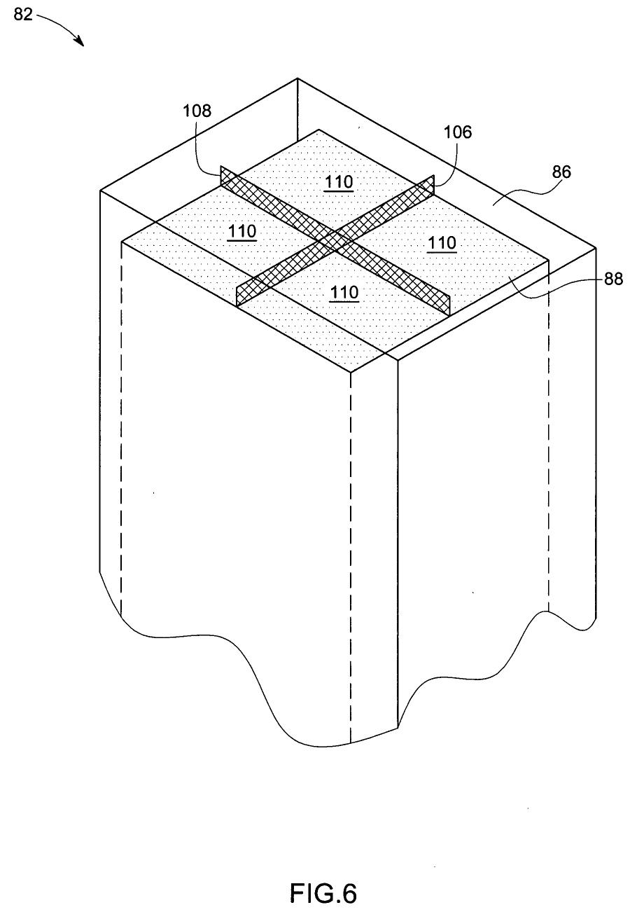

A wide variety of 3-dimensional patterns 103 could be produced within the entrance window 86. In one implementation, the pattern 103 is comprised of a plurality of first parallel planes formed across the entrance window 86. A plurality of second parallel planes may be formed so as to intersect the plurality of first parallel planes, thereby creating a plurality of grid channels within the entrance window 86. These grid channels can be utilized to guide optical photons 87 to the photocathode 88. As illustrated in FIG. 6, one such pattern, consisting of a set of intersecting planes 106, 108 forming the grid channels 110 may tend to guide the optical photons 87 to the photocathode 88, while controlling the lateral spreading of optical photons 87 in a quad PMT 82.

It should be noted that a wide variety of optical properties maybe modified to generate the three-dimensional patterns 103. These properties include, but are not limited to, creating localized crystalline regions in otherwise non-crystalline materials (such as glass), generating micro-voids within the entrance window 86, generating micro-cracks within the entrance window 86, changing the crystal structure of a crystalline entrance window 86, creating local crystal domains of different orientation than the surrounding crystalline material in a single crystal, changing the index of refraction at the focal spot 100, changing the optical absorption at the focal spot 100, changing the photon scattering properties at the focal spot 100 or the like.

Although the laser generator 96 has thus far been described generally, in one implementation the laser generator 96 may be a pulse laser generator. In addition, the laser generator 96 may be regeneratively amplified. Although nanosecond pulsed lasers may be utilized, the present technique may comprise the use of extremely short pulsed lasers, which may be referred to as “ultrafast” pulsed (<10 picoseconds) lasers, to achieve more precise patterns with minimal damage to the surrounding material. The use of ultrafast pulsed lasers such as picosecond (10⁻¹² seconds) or femtosecond (10⁻¹⁵ seconds) lasers may provide advantages such as good resolution or the ability to produce small features, minimal damage to surrounding material, improved flexibility of system (i.e. same system can process wide variety of materials), better repeatability or the like. In addition, wavelength can be chosen so that photocathode 88 is not damaged during laser processing, allowing for post-manufacture processing of multi-anode PMTs 82. The interaction mechanism between the tightly focused ultrafast laser pulses 94 and the entrance window 86 may comprise a non-resonant, non-linear, multi-photon interaction.

Because of the non-resonant interaction that may occur if the laser wavelength is not tuned to a specific absorption band of the entrance window material, the interaction process is nearly independent of the laser wavelength. This may allow the same laser generator 96 to be utilized on a wide variety of materials. Also, the wavelength of the laser beam 94 can be chosen to reduce the absorption of the laser beam 94 by the photocathode material 88, thereby reducing the damage of the photocathode material 88. If a tightly focused beam is used, the laser beam 94 may be diverging by the time it reaches the photocathode material 88 on the back surface of the entrance window 86, thereby making a multi-photon interaction with the photocathode 88 very improbable. As a multi-photon interaction requires a very high intensity, the use of tightly focused beam may therefore reduce the damage of the photocathode material 88. For example, in one implementation, an infrared laser could be used. Infrared lasers, such as titanium sapphire lasers (˜700 to 1000 nm wavelength), may be used for femtosecond laser machining, but most photocathode materials 88 show very low sensitivity at these wavelengths. This may have an impact because reducing or eliminating interaction between the laser beam 94 and the photocathode 88 may allow aspects of the present technique to be used to modify existing (i.e. already manufactured) multi-anode PMTs 82. Aspects of the present technique may also be used in the original manufacture of PMTs 82 to modify the entrance window 86 before the photocathode material 88 is deposited.

Because of the non-linear nature of the interaction, the interaction may be strongest in a region smaller than the focal spot 100. This may be true because the interaction strength may not depend linearly on the laser intensity, but may increase with the intensity according to a power law (i.e. (Intensity)^{N} where N is usually an integer).

With a multi-photon interaction, the interaction may exhibit a threshold behavior. For example, below a certain threshold, an interaction may not occur. The interaction may take place by increasing the intensity of the laser beam 94 to exceed the threshold. When utilizing tightly focused beams, the threshold may be exceeded only in the center of the focal volume 100 to provide tight control. Combining non-linear features with the threshold behavior can result in the creation of features that are smaller than the focal spot 100 of the laser beam 94. Thus, the use of ultrafast lasers can form features smaller than those generated by longer pulsed lasers.

The quick interaction produced by ultrafast lasers can create changes in optical properties in small regions without transferring significant heat to the surrounding material. For example, in the case of using ablation to generate micro-voids within the entrance window 86, the use of a nanosecond pulse may result in the relatively slow heating of the sample through its melting point and finally to the point of vaporization. During the heating process, significant heat may diffuse out of the region of the focal spot 100 of the laser beam 94. This excessive heat transfer to the surrounding material can result in a larger feature size or in the creation of cracks or other damage. Using ultrafast pulses (faster than the time required for heat diffusion), on the other hand, can cause ablation by the direct transition from solid to plasma, resulting in relatively little heating of the surrounding material. This may result in physical changes in materials with the minimal possible deposition of heat in the material surrounding the interaction point. Patterning or machining with ultrafast pulses can therefore create complex patterns with good repeatability.

As set forth above, the system 92 may result in the reduction of optical crosstalk in the entrance window 86 of the multi-anode photomultiplier tubes (PMT) 82. The lasers patterning may provide very fine control over the light spreading and scattering properties of the entrance window 86 of the multi-anode PMT 82. Also, the use of laser processing may result in the PMT 82 that is more mechanically rugged than one that has been modified by, for example, making saw cuts or grooves in the surface of the PMT entrance window 86. Additionally, the use of laser processing may produce less dead space than other methods, thereby improving detection efficiency. As will be appreciated by those skilled in the art, a wide variety of imaging systems such as computed tomography (CT), positron emission tomography (PET), single photon emission computed tomography (SPECT), and x-ray imaging may be improved via aspects of the present technique.

By reducing optical crosstalk in the entrance windows 86 of multi-anode PMTs 82, PET detector blocks may employ a larger number of smaller crystals to improve the spatial resolution of the PET system. Alternatively, fewer multi-anode PMTs 82 may be used to obtain similar resolution, thereby reducing cost.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of manufacturing a multi-anode photomultiplier tube, the method comprising:
altering one or more optical properties within an entrance window of the multi-anode photomultiplier tube at a focal spot via a laser; and
translating the focal spot relative to the entrance window for creating a three-dimensional pattern within the entrance window, the three-dimensional pattern having the one or more optical properties altered.

2. The method of claim 1, further comprising focusing the laser at the focal spot via a focusing device.

3. The method of claim 1, wherein the three-dimensional pattern comprises:
a plurality of first planes formed across the entrance window; and
a plurality of second planes formed across the entrance window, the plurality of second planes intersecting the plurality of first planes to form a plurality of channels within the entrance window for controlling, spreading of optical photons in the entrance window.

4. The method of claim 1, wherein the laser comprises a focused pulsed laser.

5. The method of claim 1, wherein the laser comprises an ultrafast laser.

6. The method of claim 1, wherein the laser is generated via a titanium sapphire laser.

7. The method of claim 1, wherein the laser is generated via a regeneratively amplified laser.

8. The method of claim 1, wherein the entrance window comprises glass.

9. The method of claim 1, wherein the entrance window comprises ceramic.

10. The method of claim 1, wherein the altering the one or more optical properties comprises creating localized crystal domains of different orientation with respect to surrounding crystalline material.

11. The method of claim 1, wherein the altering the one or more optical properties comprises creating localized crystalline regions within a non-crystalline material.

12. The method of claim 1, wherein the altering the one or more optical properties comprises creating localized non-crystalline regions within a crystalline material.

13. The method of claim 1, wherein the altering the one or more optical properties comprises creating micro-voids within the entrance window.

14. The method of claim 1, wherein the altering the one or more optical properties comprises creating micro-cracks within the entrance window.

15. The method of claim 1, wherein the altering the one or more optical properties comprises changing optical absorption at the focal spot.

16. The method of claim 1, wherein the altering the one or more optical properties comprises changing photon scattering properties at the focal spot.

17. The method of claim 1, wherein the altering the one or more optical properties comprises changing index of refraction at the focal spot.

18. A multi-anode photomultiplier tube, comprising:
an entrance window having a three-dimensional pattern with one or more optical properties altered, the three-dimensional pattern adapted to control spreading of optical photons within the entrance window.

19. The multi-anode photomultiplier tube of claim 18, further comprising a photocathode for converting the optical photons into electrical signals.

20. The multi-anode photomultiplier tube of claim 18, wherein the entrance window comprises glass.

21. The multi-anode photomultiplier tube of claim 18, wherein the three-dimensional pattern comprises:
a plurality of first planes formed across the entrance window; and
a plurality of second planes formed across the entrance window, the plurality of second planes intersecting the plurality of first planes to form a plurality of channels within the entrance window for controlling, spreading of optical photons in the entrance window.

22. A detector unit configured to detect a radiation, the detector unit comprising:
a scintillator block comprising one or more scintillator elements for converting the radiation into optical photons; and
one or more multi-anode photomultiplier tubes coupled to the scintillator block, each multi-anode photomultiplier tube comprising:
an entrance window having a three-dimensional pattern with one or more optical properties altered, the three-dimensional pattern adapted to control spreading of optical photons within the entrance window.

23. The detector unit of claim 22, wherein the three-dimensional pattern comprises:
a plurality of first planes formed across the entrance window; and
a plurality of second planes formed across the entrance window, the plurality of second planes intersecting the plurality of first planes to form a plurality of channels within the entrance window for controlling, spreading of optical photons in the entrance window.

24. An imaging system, comprising:
an array of detector units disposed around a subject for detecting radiation transmitted through the subject and to generate a detector output signal in response to the detected radiation, the detector unit comprising a scintillator block and one or more multi-anode photomultiplier tubes coupled to the scintillator block, each multi-anode photomultiplier tube comprising an entrance window having a three-dimensional pattern with one or more optical properties altered, the three-dimensional pattern adapted to control spreading of optical photons within the entrance window;
a data acquisition system for acquiring the detector output signal;
a coincidence detector coupled to the data acquisition system for registering a coincidence event;
an image reconstructor coupled to the data acquisition system and the coincidence detector for generating an image signal in response to the detector output signal on registering the coincidence event; and
a processor for controlling operation of at least one of the data acquisition system, the coincidence detector and the image reconstructor.

25. The imaging system of claim 22, wherein the three-dimensional pattern comprises:
a plurality of first planes formed across the entrance window; and
a plurality of second planes formed across the entrance window, the plurality of second planes intersecting the plurality of first planes to form a plurality of channels within the entrance window for controlling, spreading of optical photons in the entrance window

26. A method for imaging a volume, the method comprising:
detecting radiation transmitted through a subject via an array of detector units disposed around the subject, the detector unit comprising a scintillator block and one or more multi-anode photomultiplier tubes coupled to the scintillator block, each multi-anode photomultiplier tube comprising an entrance window having a three-dimensional pattern with one or more optical properties altered, the three-dimensional pattern adapted to control spreading of optical photons within the entrance window;
generating a detector output signal in response to the detected radiation;
acquiring the detector output signal;
registering a coincidence event;
generating an image signal in response to the detector output signal on registering the coincidence event.
